(19) United States
(12) Patent Application Publication
(10) Pub. No.: US 2025/0151742 A1
(43) Pub. Date: May 15, 2025

(54) BULK FOOD PROCESSOR WITH ANGLED FAN

(71) Applicant: Laitram, L.L.C., Harahan, LA (US)

(72) Inventors: Christopher G. Greve, Covington, LA (US); Robert S. Lapeyre, New Orleans, LA (US); Joseph F. Kovacs, New Orleans, LA (US)

(21) Appl. No.: 19/020,638

(22) Filed: Jan. 14, 2025

Related U.S. Application Data
(63) Continuation of application No. 16/312,065, filed on Dec. 20, 2018, now abandoned.
(60) Provisional application No. 62/365,086, filed on Jul. 21, 2016.

(51) Int. Cl. A23B 9/02; A23B 2/00; A23B 2/22; A23B 2/42; A23L 5/00; A23L 5/10; A23L 25/00

(52) U.S. Cl. CPC A23B 9/025; A23B 2/00; A23B 2/001; A23B 2/22; A23B 2/425; A23L 5/00; A23L 5/13; A23L 25/30

(57) ABSTRACT

Apparatus and methods for bulk processing items on a conveyor belt using an angled axial fan that extends obliquely into a processing chamber that performs a pasteurization or other process on the conveyed items. The angled axial fan enhances air flow around a product being processed on the conveyor belt.

### RELATED APPLICATIONS

This application is a continuation of U.S. patent application Ser. No. 16/312,065, which is a 371 of PCT/US17/43013, which claims priority to U.S. Provisional Patent Application No. 62/365,086 filed Jul. 21, 2016 and entitled “Bulk Food Processor with Angled Fan”, the contents of which are herein incorporated by reference.

### BACKGROUND

The invention relates generally to a processor for food articles and more particularly to apparatus and methods for pasteurizing food.

In preparing foods or other items in bulk, the items may be conveyed through a processing chamber using a conveyor belt. A process, such as heating, cooling or steaming the articles may be performed. For example, it may be desirable to pasteurize nuts, such as almonds, in bulk using a conveyor belt. Pasteurization may involve heating and—or cooling the nuts using heated or cooled air circulated over the conveyed nuts. It may be desirable to enhance the flow of air in certain processing chambers to make the processing of articles more efficient.

### SUMMARY

A bulk food processor employs an angled axial air flow fan to circulate air over a product conveyed through a processing chamber. Product is conveyed through the processing chamber by a conveyor belt, which has a returnway that passes back through the processing chamber.

According to one aspect, a bulk processor for an item comprises a processing chamber having a product inlet and a product outlet, a conveyor for conveying product through the processing chamber and an axial flow fan for circulating air around the product. According to another aspect, a bulk processor for an item comprises a processing chamber having an inlet and an outlet, a conveyor belt for conveying product through the processing chamber, the conveyor belt having a carryway and returnway passing through the chamber and an air circulator for circulating air along an air flow path that passes through the carryway and the returnway.

### BRIEF DESCRIPTION OF THE DRAWINGS

These features and aspects of the invention, as well as its advantages, are described in more detail in the following description, appended claims, and accompanying drawings, in which:

FIG. 1 is an isometric view of a bulk food processor according to an embodiment of the invention;

FIG. 2 is another view of the bulk food processor of FIG. 1;

FIG. 3 is a cut-away isometric view of the bulk food processor of FIG. 1;

FIG. 4 is a cut-away front view of the bulk food processor of FIG. 1, showing the interior of a processing chamber;

FIG. 5 is a cut-away isometric view of the bulk food processor of FIG. 1;

FIG. 6 is a cut-away front view of an axial flow fan used in the bulk food processor of FIG. 1;

FIG. 7 is an isometric interior view of the axial flow fan of FIG. 6; and

FIG. 8 is a cut-away front view of the interface between the two processing chambers of the bulk food processor of FIG. 1.

### DETAILED DESCRIPTION

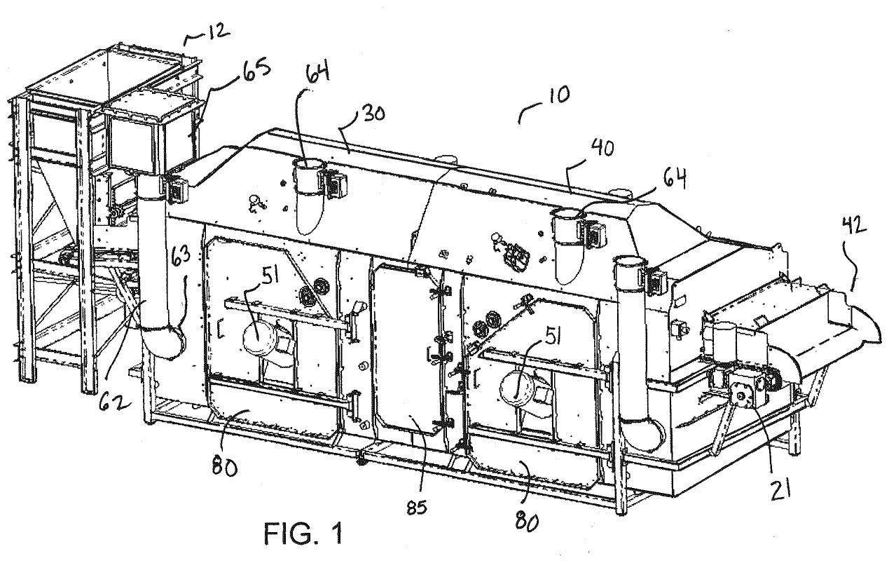

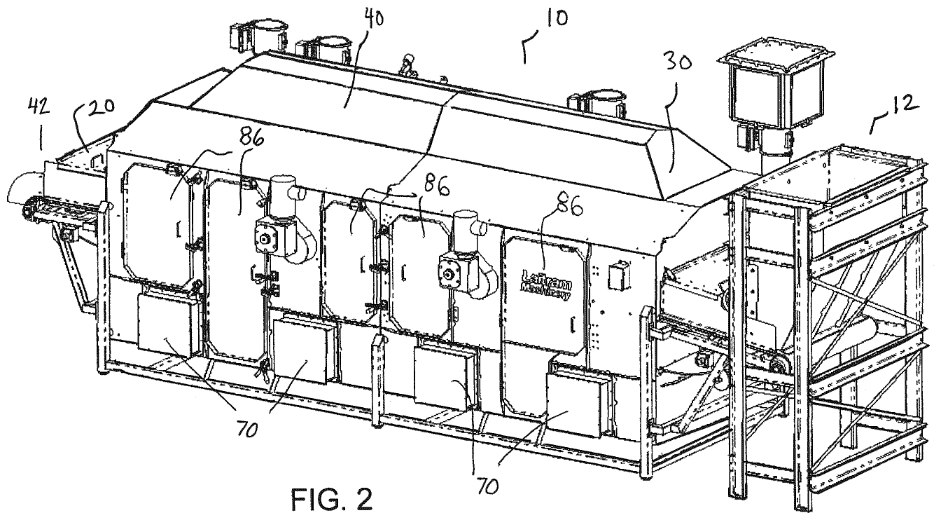

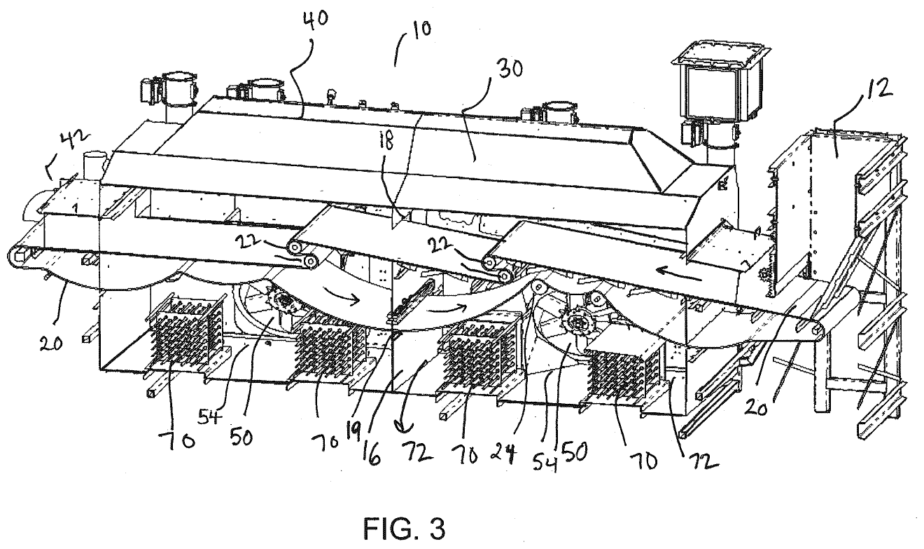

A processor 10 that operates according to and embodies features of the invention is shown in FIGS. 1 and 2. FIG. 3 is a cut-away side view of the processor 10. The processor 10 changes the temperature of an item conveyed through the processor. For example, the processor can be used to raise the temperature of nuts being pasteurized, pasteurize nuts using steam, dry pasteurized nuts, cool pasteurized nuts or perform any suitable process on any suitable article, not limited to nuts.

The illustrative processor 10 has an entrance for items to be processed, shown as a hopper 12. A conveyor belt 20 receives items from the hopper near the infeed of the conveyor belt and conveys the items along a processing path, where a process, such as heating, cooling or steam pasteurizing, is performed on the items. In one embodiment, the belt is a foraminous belt with sufficient opening to allow airflow therethrough. The conveyor belt 20 is trained around drive and idle sprockets (not shown) at opposite ends of an upper carryway that traverses the processor, and driven by a motor 21 or other suitable drive. Diverting rollers or drums 24 or other guides guide the endless conveyor belt 20 along a returnway within the processor below the carryway. The conveyor belt includes repositioning flips formed by repositioning rollers 22 along the upper carryway, as described in U.S. Pat. Nos. 8,028,618 and 5,410,951, the contents of which are herein incorporated by reference. The invention is not limited to the illustrative conveyor belt and any suitable means can be used to convey articles through the processor.

The illustrative processing path comprises serial processing chambers 30, 40 in communication with each other. Processed items exit the processor 10 at exit 42.

Each processing chamber 30, 40 includes an air circulator, shown as an axial flow fan 50 for circulating air along an air flow path that intersects items being conveyed atop the conveyor belt 20 along the carryway. The conveyor belt is foraminous to allow the air to pass through. Other features of such a processor as described thus far are given in U.S. Pat. No. 6,274,188, “Method for Steam-Cooking Shrimp at Reduced Temperatures to Decrease Yield Loss,” Aug. 14, 2001, and PCT Published Application Number WO 2015/133981, entitled “Low-Temperature, Forced-Convection, Steam-Heating of Nuts”, incorporated herein by reference. One example of such a cooker is the CoolSteam® cooker manufactured and sold by Laitram Machinery, Inc., of Harahan, Louisiana, U.S.A.

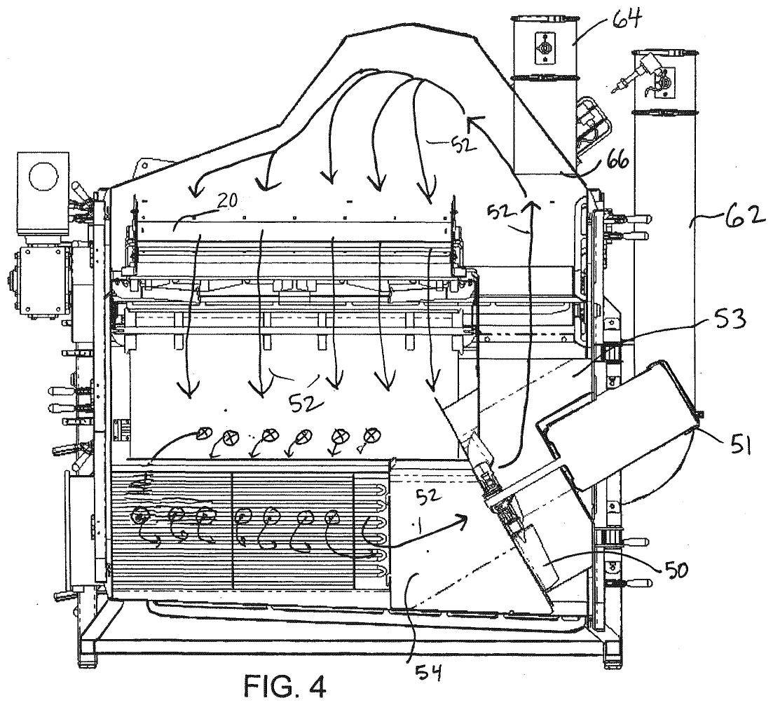

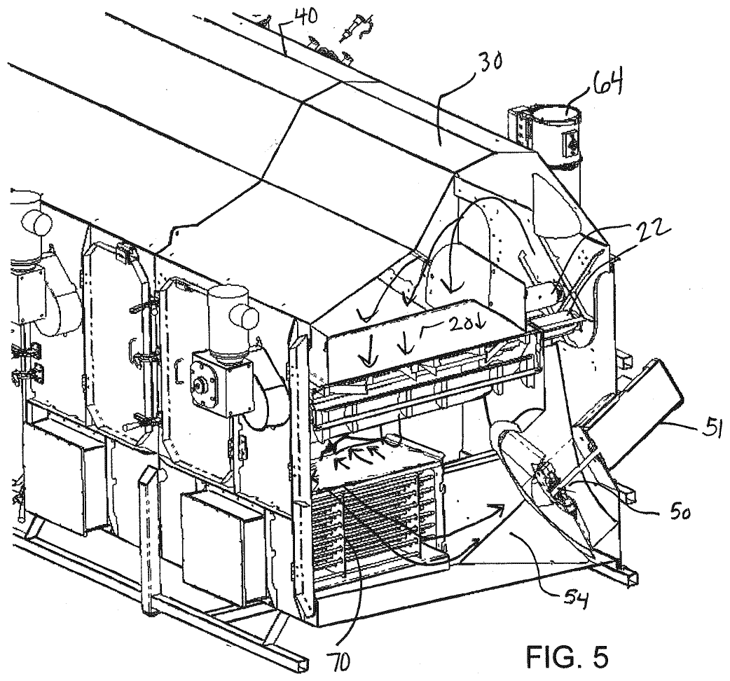

FIGS. 4 and 5 and are cut-away views of the first processing chamber 30, illustrating the air flow path, represented by arrows 52 in FIG. 4. The axial air flow fan 50, driven by a motor 51, pulls air from a lower duct 54 below the conveyor belt 20, and pushes air up into a fan flow chamber 53 on the side of the processing chamber 30. The illustrative fan flow chamber 53 extends vertically up the side of the processing chamber 30. The top of the processing chamber 30 is shaped to direct the airflow over the product on the conveyor belt 20. The region above the conveyor belt forms a high pressure region, while the region below the conveyor belt forms a lower pressure region. Air is pushed through the foraminous conveyor belt into the low pressure region below the conveyor belt. The processing chamber 30 also includes an air inlet 62 for pulling in ambient air and an air outlet 64 for releasing air to the ambient, if necessary. Processing chamber 40 is similar to processing chamber 30.

The air circulated by the axial flow fan 50 may be heated, cooled, or at ambient temperature. In the illustrative embodiment, each processing chamber 30, 40 includes two sets of heating or cooling coils 70 below the conveyor belt on each side of the lower duct 54. Air pushed through the conveyor belt is deflected off the sealed top of the lower duct 54, over the covered tops of the coils 70 into a region 72 (shown in FIG. 3) between the front or rear of each processing chamber and the coils 70, opposite the lower duct 54. The air is them pulled through the coils 70 to either heat or cool or otherwise process the air before it passes into the lower duct 54 and the axial flow fan 50 pulls the heated, cooled or otherwise processed air into the fan flow chamber 53 and over the conveyed product in the processing chamber 30 to either heat, cool or otherwise process the conveyed product.

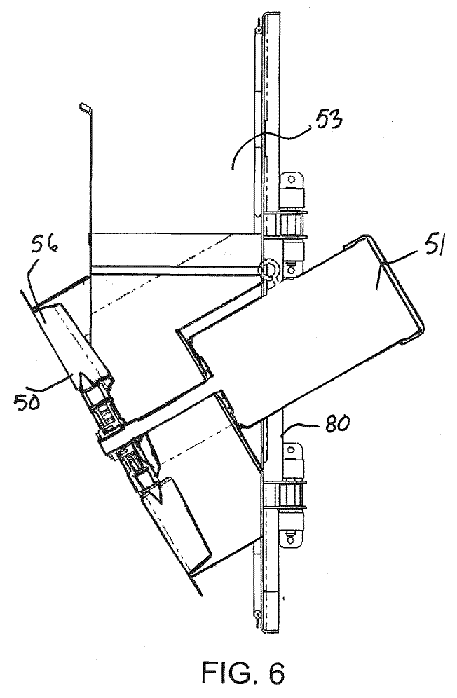

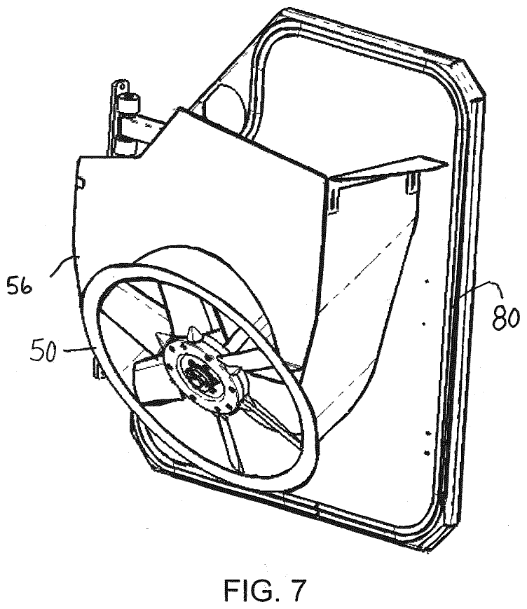

The illustrative axial flow fan 50, shown in detail in FIGS. 6 and 7, may be mounted in a door 80 of each processing chamber to facilitate access to the axial flow fan. The illustrative axial flow fan is mounted obliquely, with the fan motor 51 extending obliquely through the door 80 and into the air duct formed in the respective processing chamber. The axial flow fan 50 and motor 51 may be mounted at any suitable angle to facilitate airflow through the fan flow chamber 53 extending parallel to the door 80 in which the axial flow fan 50 and motor 51 are mounted. In one embodiment, the axial flow fan 50 and motor 51 are tilted inward at an angle between about 15° and about 45° and preferably about 30°, though the invention is not so limited. The axial flow fan 50 has a shroud 56 that extends to and interfaces with the lower duct 54 at an angle, so that the bottom of the fan is closer to the door 80 than the top of the fan.

Referring back to FIG. 1, as mentioned, each processing chamber 30, 40 includes an ambient air inlet 62 for pulling in ambient air and an air outlet 64. The air inlet 62 comprises a duct open to the environment having an outlet 63 that is below the conveyor belt 20 and in communication with a chamber 72 adjacent the coils 70. The air inlet 62 may include a filter 65 at the input to filter the air before passing it into the lower chamber 72. The air outlet 64 comprises a duct 64 having an entrance 66 (see FIG. 4) at the top of the vertical fan flow chamber 53 for bleeding off air, if necessary. The duct 64 has a damper or other suitable regulator for regulating the release of air from the associated processing chamber 30 or 40. In one embodiment, the air inlet 62 and—or air outlet 64 includes one or more sensors, for example, a humidity sensor, a temperature sensor or other suitable sensor, for measuring one or more properties of the air. A controller can control the opening and shutting of the air ducts 62, 64 based on measurements from the sensors.

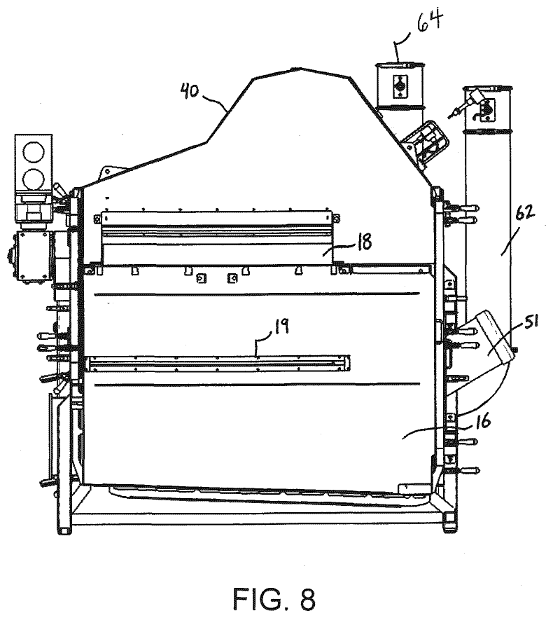

As described above, the processor 10 comprises two serial chamber 30, 40 that perform a process, such as heating, pasteurizing, cooling or drying, on a product conveyed through the chambers, though the processor may include any suitable number of chambers. As shown in FIGS. 3 and 8, the chambers 30, 40 are separated by a wall 16 or other interface that allows product to exit the first product chamber 30 and enter the second processing chamber 40. The illustrative wall 16 includes an upper opening 18 that allows the upper carryway of the conveyor belt 20 to pass from the first chamber 30 into the second chamber 40, along with any processed product conveyed by the conveyor belt. The upper opening 18 may have a seal, such as a rubber sheet, to limit airflow between the two chambers while allowing product to pass. The wall 16 includes a slot 19 below the upper opening 18 for allowing the conveyor belt 20 to pass from the second chamber 40 into the first chamber 30. Thus, the returnway of the conveyor belt is contained within the processing chambers 30, 40, which may promote hygiene and facilitate cleaning of the conveyor belt.

The processor may also include a central door 85, between the doors 80 shown in FIG. 1, for accessing an interior area of the processor at the interface between the two processing chambers 30, 40. One or more doors 86 may be provided on the other side of the processor for interior access, as shown in FIG. 2.

In one embodiment, a plurality of processors may be used together to pasteurize a product, such as almonds or other nuts. A first processor with an angled axial fan may receive raw almonds from an input, such as a hopper, and circulate warm air over the raw almonds as they are conveyed through the first processor, to pre-heat the almonds. The first processor passes the pre-heated almonds to a second processor having an angled axial fan, which uses steam and air combined and blown by the angled axial fan, to pasteurize the almonds as they are conveyed through the second processor. Then, the second processor can pass the pasteurized almonds to a third processor, which can used heated air circulated using an angled axial fan to dry the pasteurized nuts as they are conveyed through the third processor. Finally, a fourth processor, which can used cooled air circulated through a cooling chamber by an angled axial fan, cools the pasteurized, dried nuts as they pass through the cooling chamber.

The invention is not limited to the illustrative embodiments.

What is claimed is:

1. A bulk processor for an item, comprising:
a processing chamber having a product inlet, a product outlet and a door for accessing the processing chamber;
a conveyor for conveying product from the product inlet to the product outlet through the processing chamber, the processing chamber forming a high pressure region above the conveyor and a low pressure region in a lower duct below the conveyor;
an axial flow fan mounted obliquely in the door below the conveyor and having a shroud that extends to and interfaces with the low pressure region at an angle, so that the bottom of the axial flow fan is closer to the door than the top of the axial flow; and
a fan flow chamber extending vertically up a side of the processing chamber for receiving and directing air from the axial flow fan to the high pressure region and over the conveyor.

2. The bulk processor of claim 1, wherein the conveyor comprises a foraminous conveyor belt that allows air to be pushed from the high pressure region to the low pressure region.

3. The bulk processor of claim 1, further comprising a heater below the conveyor for heating air circulated by the fan.

4. The bulk processor of claim 3, wherein the heater comprises temperature coils.

5. The bulk processor of claim 1, further comprising an air inlet for passing ambient air into the processing chamber.

6. The bulk processor of claim 5, wherein the air inlet comprises a duct open to the environment having an outlet below the conveyor and in communication with the low pressure region.

7. The bulk processor of claim 5, wherein the air inlet includes a sensor and controller for controlling the opening and shutting of the air inlet based on a measurement from the sensor.

8. The bulk processor of claim 1, further comprising an air outlet for selectively releasing air from the processing chamber.

9. The bulk processor of claim 8, wherein the air outlet comprises a duct having an entrance at the top of the fan flow chamber.

10. The bulk processor of claim 9, wherein the air outlet duct includes a damper for regulating the release of air from the processing chamber based on a measurement by a sensor.

11. The bulk processor of claim 1, wherein the axial flow fan extends at an angle of about 30° relative to the door.

12. The bulk processor of claim 1, wherein the processing chamber has a shaped top to direct the airflow over product on the conveyor.
